(19) United States
(12) Patent Application Publication
(10) Pub. No.: US 2007/0136398 A1
(43) Pub. Date: Jun. 14, 2007

(54) Storage system control device, storage system control program, and storage system control method

(75) Inventor: Naoyoshi Toshine, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/373,985

(22) Filed: Mar. 14, 2006

(30) Foreign Application Priority Data
Dec. 14, 2005 (JP) 2005-360214

(51) Int. Cl. G06F 17/30

(52) U.S. Cl. 707/204

(57) ABSTRACT

There is disclosed a storage system control device, storage system control program, and storage system control method, which realize large capacity at low bit cost and improve response. A storage system control device 11 controls an online hard disk 12 and a near-line hard disk 13, and includes an online hard disk interface 22, a near-line hard disk interface 23, and a control section 21. The control section 21 receives a write request from an external host computer 2. If writing into the online hard disk 12 is possible, the control section 21 instructs the online hard disk interface 22 and near-line hard disk interface 23 about writing.

### BACKGROUND OF THE INVENTION

1. Field of the Invention

The present invention relates to a storage system control device, a storage system control program, and a storage system control method to control a hierarchical storage including primary and secondary storages.

2. Description of the Related Art

In information management systems, online hard disks are mainly used as hard disks capable of constantly accessing data at high speeds. Also logical volumes constituted by plural hard disks, such as RAID (Redundant Arrays of Inexpensive Disks), are used in order to avoid data from being lost by malfunctions or to increase volume. However, these online hard disks involve a much higher bit cost compared with offline media such as magnetic tapes. There hence have been difficulties in realizing a large-capacity information management system constituted only by online hard disks.

To solve these problems, a hierarchical storage system is used. In this system, an online hard disk capable of high-speed access as a primary storage and an offline media device of a low bit cost as a secondary storage are arranged in a hierarchical structure. In this system, however, response deteriorates extremely when the offline medium is accessed. As structural components of this hierarchical storage system, a server dedicated for hierarchization or a library device for offline media needs to be prepared. Unless the system is a large-capacity information management system, the bit cost cannot be reduced greatly.

In recent years, near-line hard disks having large capacity with low bit cost according to SATA (Serial Advanced Technology Attachment) or FATA (Fibre Attached Technology Adapted) have been used. Near-line hard disks, however, are inferior to online hard disks in view of performance and reliability, and are generally used for archives. Also, a hierarchical storage system using an online hard disk as a primary disk and a near-line hard disk as a secondary storage has been used.

Known prior art relevant to the present invention is, for example, Jpn. Pat. Appln. Laid-Open Publication No. 2005-165486. A file management device, a storage management system, a storage management method, a program, and a recording medium virtually manage plural kinds of storage media as a single storage.

In a conventional hierarchical storage system, however, all accesses from a host computer are made to a primary storage, and internal copying from the primary storage to a secondary storage is required. Consequently, the operation of internal copying causes deterioration of response.

### SUMMARY OF THE INVENTION

The present invention has been made to solve the above problems and has an object of providing a storage system control device, a storage system control program, and a storage system control method, which realize large capacity and low bit cost and improve response.

To achieve the above object, according to a first aspect of the present invention, a storage system control device controls a primary storage and a secondary storage which drives at a lower speed than the primary storage, and comprises: a primary storage interface that performs writing into and reading from the primary storage; a secondary storage interface that performs writing into and reading from the secondary storage; and a control section that receives a write request from an external host computer and instructs the primary and secondary storage interfaces about writing if writing into the primary storage is possible.

In the storage system control device according to the present invention, the control section receives a read request from the external host computer and instructs the primary storage interface about reading if reading from the primary storage is possible, or instructs the secondary storage interface about reading if reading from the primary storage is impossible.

In the storage system control device according to the present invention, the control section receives a write request from the external host computer and instructs the secondary storage interface about writing if writing into the primary storage is impossible.

In the storage system control device according to the present invention, the control section receives a write request for writing into an unused block, from the external host computer, assigns an assignable block in the primary storage to a primary block if there is any assignable block in the primary storage, and assigns another assignable block in the secondary storage to a secondary block.

In the storage system control device according to the present invention, if a primary block satisfies a predetermined first condition, the control section deletes assignment to the primary block, and starts measuring access frequency of access to a secondary block corresponding to the primary block.

In the storage system control device according to the present invention, if a secondary block satisfies a predetermined second condition and if there is an assignable block in the primary storage, the control section assigns the assignable block to a primary block corresponding to the secondary block, and copies data from the secondary block to the primary block.

In the storage system control device according to the present invention, if there is no assignable block in the primary storage, the control section sets, as an assignable block, such a primary block that satisfies a predetermined third condition.

In the storage system control device according to the present invention, the first condition is that a time period for which the primary block as a target has not been accessed exceeds a predetermined non-access time period threshold value.

In the storage system control device according to the present invention, the second condition is that access frequency of access to the secondary block as a target exceeds a predetermined access frequency threshold value.

In the storage system control device according to the present invention, the third condition is that the primary block has the longest non-access time among primary blocks being in a predetermined determination period from mapping of the primary blocks.

In the storage system control device according to the present invention, the control section manages each of the primary and secondary blocks as an active or inactive block, if a block satisfies a predetermined condition and is determined as being accessed at low use frequency, the control section sets the block as an inactive block, if all blocks in a physical volume in the primary storage or secondary storage are inactive blocks, the control section stops the physical volume, and if there is an active block in the physical volume, the control section lets the physical volume operate.

In the storage system control device according to the present invention, if the primary block satisfies a predetermined fourth or fifth condition, the control section sets the secondary block as an inactive block, and if the secondary block satisfies a predetermined sixth condition, the control section sets the secondary block as an active block.

In the storage system control device according to the present invention, the fourth condition is that before a predetermined determination period elapses from mapping of a primary block as a target, a time period for which the primary block has not been accessed exceeds a predetermined non-access time threshold value, the fifth condition is that before a predetermined determination period elapses from mapping of a primary block as a target, a time period for which the primary block has not been accessed does not exceed a predetermined non-access time threshold value, and the sixth condition is that access frequency of access to a secondary block as a target exceeds a predetermined access frequency threshold value.

According to a second aspect of the present invention, a storage system control program makes a computer execute control of a primary storage and a secondary storage which drives at a lower speed than the primary storage, and comprises: a storage management step that receives a write request from an external host computer and determines whether writing into the primary storage is possible or not; and a storage control step that gives an instruction about writing into the primary and secondary storages if writing into the primary storage is determined to be possible by the storage management step.

In the storage system control program according to the present invention, the storage management step receives a read request from the external host computer, and determines whether reading from the primary storage is possible or not, and if reading from the primary storage is determined to be possible by the storage management step, the storage control step instructs a primary storage interface about reading, or if reading from the primary storage is determined to be impossible by the storage management step, the storage control step instructs a secondary storage interface about reading.

In the storage system control program according to the present invention, if writing into the primary storage is determined to be impossible by the storage management system, the storage control step instructs the secondary storage interface about writing.

In the storage system control program according to the present invention, the storage management step receives a write request for writing into an unused block from the external host computer, assigns an assignable block in the primary storage to a primary block if there is an assignable block in the primary storage, and assigns an assignable block in the secondary storage to a secondary block.

In the storage system control program according to the present invention, if a primary block satisfies a predetermined first condition, the storage management step deletes assignment to the primary block, and starts measuring access frequency of access to a secondary block corresponding to the primary block.

In the storage system control program according to the present invention, if a secondary block satisfies a predetermined second condition and if there is an assignable block in the primary storage, the storage management step assigns the assignable block to a primary block corresponding to the secondary block, and the storage control step copies data from the secondary block to the primary block.

According to a third aspect of the present invention, a storage system control method of controlling a primary storage and a secondary storage which drives at a lower speed than the primary storage comprises: a storage management step that receives a write request from an external host computer and determines whether writing into the primary storage is possible or not; and a storage control step that gives an instruction about writing into the primary and secondary storages if writing into the primary storage is determined to be possible by the storage management step.

The present invention accordingly achieves a storage system having large capacity with low bit cost and improves response of the storage system.

### BRIEF DESCRIPTION OF THE DRAWINGS

FIG. 1 is a block diagram showing an example of structure of a hierarchical storage system according to the present invention;

FIG. 2 is a block diagram showing an example of configuration of logical volumes in the hierarchical storage system according to the present invention;

FIG. 3 is a flowchart showing an example of operation of mapping processing according to the present invention;

FIG. 4 is a flowchart showing an example of operation of a first optimization processing according to the present invention;

FIG. 5 is a flowchart showing an example of operation of a second optimization processing according to the present invention; and

FIG. 6 is a flowchart showing an example of operation of a third optimization processing.

### DETAILED DESCRIPTION OF THE PREFERRED EMBODIMENTS

Hereinafter, an embodiment of the present invention will be described with reference to the drawings.

In this embodiment, a hierarchical storage system which uses an online hard disk as a primary storage as well as a near-line hard disk as a secondary storage will be described.

Structure of the hierarchical storage system according to the present invention will be described first.

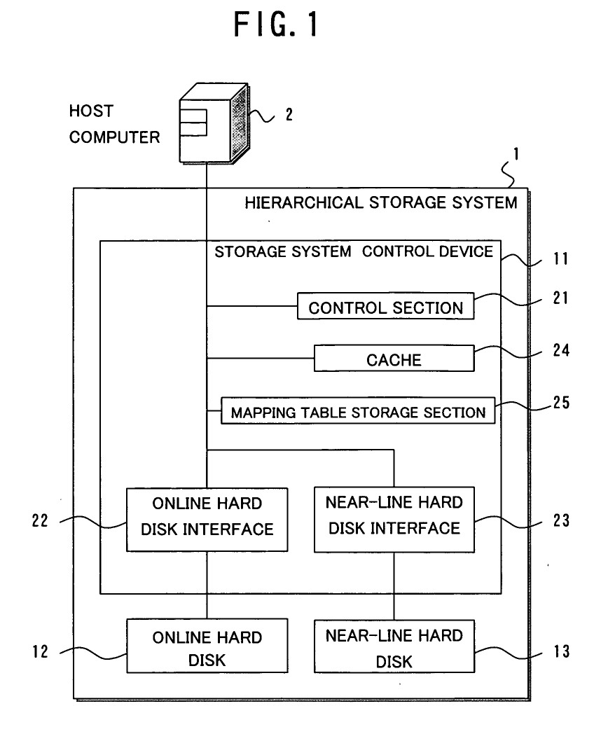

FIG. 1 is a block diagram showing an example of the structure of a hierarchical storage system according to the present invention. This hierarchical storage system 1 is connected to and accessed from a host computer 2. The hierarchical storage system 1 also has a storage system control device 11, an online hard disk 12, and a near-line hard disk 13. The storage system control device 11 has a control section 21, an online hard disk interface 22, a near-line hard disk interface 23, a cache 24, and a mapping table storage section 25. The control section 21 serves to control the storage system control device 11. The online hard disk interface 22 serves to connect to the outline hard disk 12. The near-line hard disk interface 23 serves to connect to the near-line hard disk 13. The cache 24 serves to temporarily store data exchanged with the host computer 2. The mapping table storage section 25 stores mapping of logical volumes assigned to the online hard disk 12 and the near-line hard disk 13.

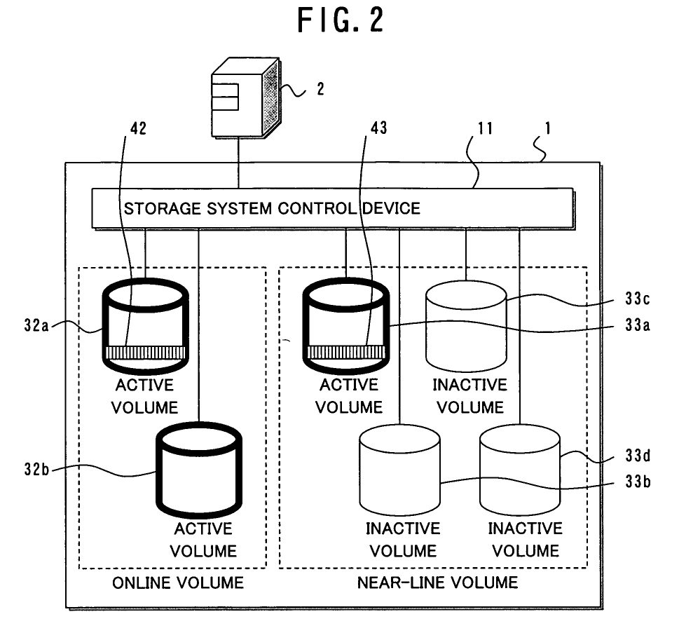

FIG. 2 is a block diagram showing an example of configuration of logical volumes in the hierarchical storage system according to the present invention. In this example, as logical volumes, online volumes 32a and 32b are assigned internally to the online hard disk 12, and near-line volumes 33a, 33b, 33c, and 33d are assigned internally to the near line hard disk 13. These volumes are referred to as virtual volumes from the host computer 2.

The control section 21 manages, in units of blocks, the mapping of logical volumes in the online hard disk 12 and the near line hard disk 13. The control section 21 also holds the mapping in form of a mapping table in the mapping table storage section 25. Blocks mapped to the online hard disk 12 are called online blocks 42. Blocks mapped to the near line hard disk 13 are called near line blocks 43.

Each of logical volumes in the online hard disk 12 and near line hard disk 13 is set to an active volume or inactive volume, and held on the mapping table. Physical volumes corresponding to active volumes are supplied with electric power. If all the logical volumes assigned to a physical volume are inactive volumes, the physical volume can be powered off. Each block in a logical volume is set to an active or inactive block, and held on the mapping table. When all the blocks in a logical volume are inactive blocks, the logical volume is an inactive volume. If there is any active block in a logical volume, the logical volume is an active volume.

The control section 21 also measures non-access time and access frequency for every block, and adds the non-access time and access frequency to the mapping table, to manage the non-access time and access frequency. The non-access time indicates time how long a block as a target has not been accessed, and is reset to zero at the time point when the block is accessed. The access frequency indicates how many times a near-line block as a target is accessed per unit time, and is measured periodically.

A determination period, a non-access time threshold value, and access frequency threshold value are previously set in the control section 21. The determination period is a period when whether a mapped block has been accessed or not is determined. A block of which non-access time has exceeded the non-access time threshold value is determined as being used at low frequency. Mapping of this block to an online block is deleted, for example. A block of which access frequency has exceeded the access frequency threshold value is determined as being used at high frequency. The block is then, for example, copied internally to an online block.

Next, operation of a storage system control device according to the present invention will be described.

As the operation of the storage system control device, a mapping processing and first to third optimization processing will be described below.

The mapping processing will be described first.

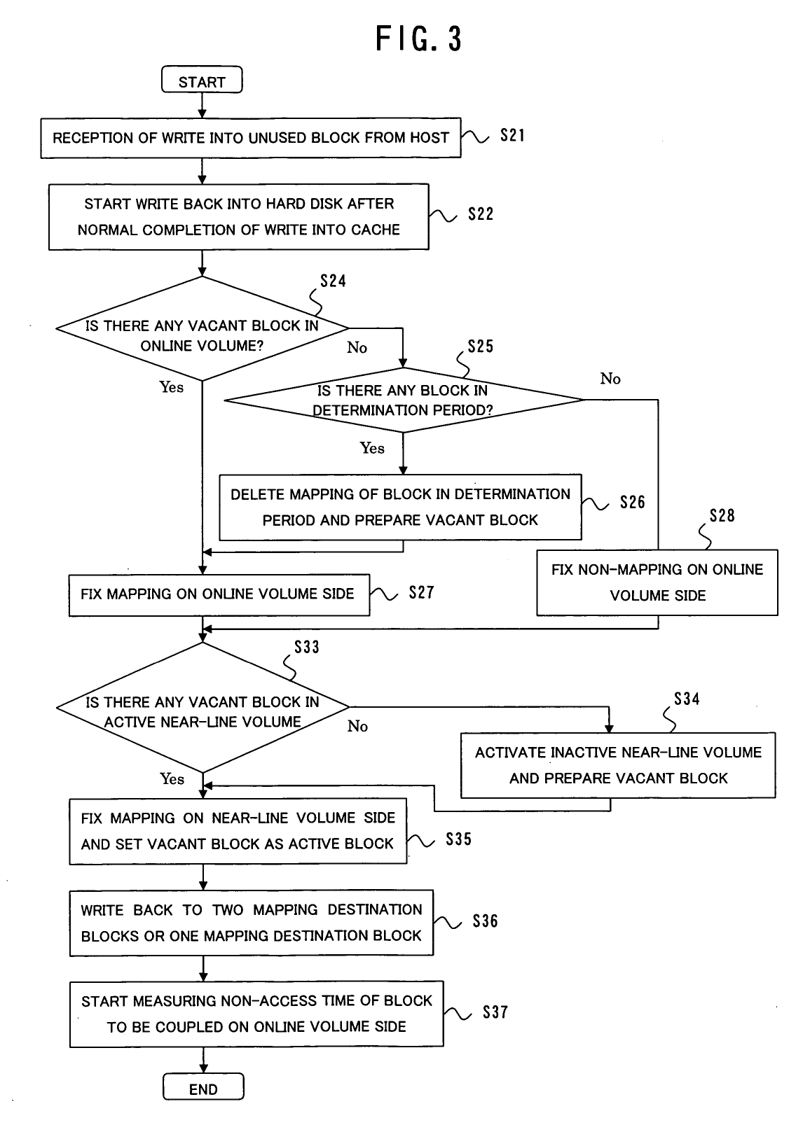

The control section 21 performs the mapping processing when Write access to an unused block is made from the host computer 2 to the storage system control device 11. FIG. 3 is a flowchart showing an example of the mapping processing according to the present invention.

At first, the control section 21 receives a Write request to an unused block from the host computer 2 (S21). Next, the control section 21 performs Write into the cache 24. If the Write is complete normally, the control section 21 then starts Write Back operation as follows (S22).

Next, the control section 21 determines whether there is any vacant block or not in an online volume (S24). If there is a vacant block (S24, Y), the control section 21 fixes mapping on the online volume side (S27), and goes to a processing step S33. Otherwise, if there is no vacant block (S24, N), the control section 21 determines whether any block is in the determination period (S25). If there are blocks in the determination period (S25, Y), mapping of the block that has the longest non-access period is deleted among the blocks in the determination period, thereby to prepare a vacant block (S26). The control section 21 then goes to a processing step S27. Otherwise, if there is no block in the determination period (S25, N), the control section 21 fixes non-mapping on the online volume side (S28), and goes to the processing step S33.

Next, in the processing step S33, the control section 21 determines whether there is any vacant block in an active near-line volume (S33). If there is a vacant block (S33, Y), the control section 21 goes to a processing step S35. Otherwise, if there is no vacant block (S33, N), the control section 21 activates a non-active near-line volume, to prepare a vacant block (S34), and then goes to a processing step S35.

Next, in the processing step S35, the control section 21 fixes mapping on the near-line volume side, and the block as a mapping destination is set as an active block (S35). Next, the control section 21 performs WriteBack on the block as a mapping destination (S36). If mapping to both the online and near-line volumes is carried out, WriteBack is performed at two corresponding positions. Otherwise, if mapping only to the near-line volume is performed, WriteBack is performed at one corresponding position. Next, the control section 21 starts measuring non-access time of a block on the online volume side to be coupled (S37), and terminates this flow.

According to this mapping processing, mapping is performed as much as possible to two blocks, i.e., one online block and one near-line block, so that writing is carried out on the online and near-line blocks. Thus, internal copying from the online block to a near-line block can be omitted. Response can accordingly improve compared with a conventional hierarchical storage system which necessitates internal copying from a primary storage to a secondary storage. The online hard disk 12 appears to the user to have the volume of the near line hard disk 13. Large capacity can thus be ensured at low cost. Even if the capacity of the online volume runs short, online blocks used at low use frequency are mapped or only offline blocks are mapped. Therefore, hard disks can be used efficiently.

Described next will be a first optimization processing.

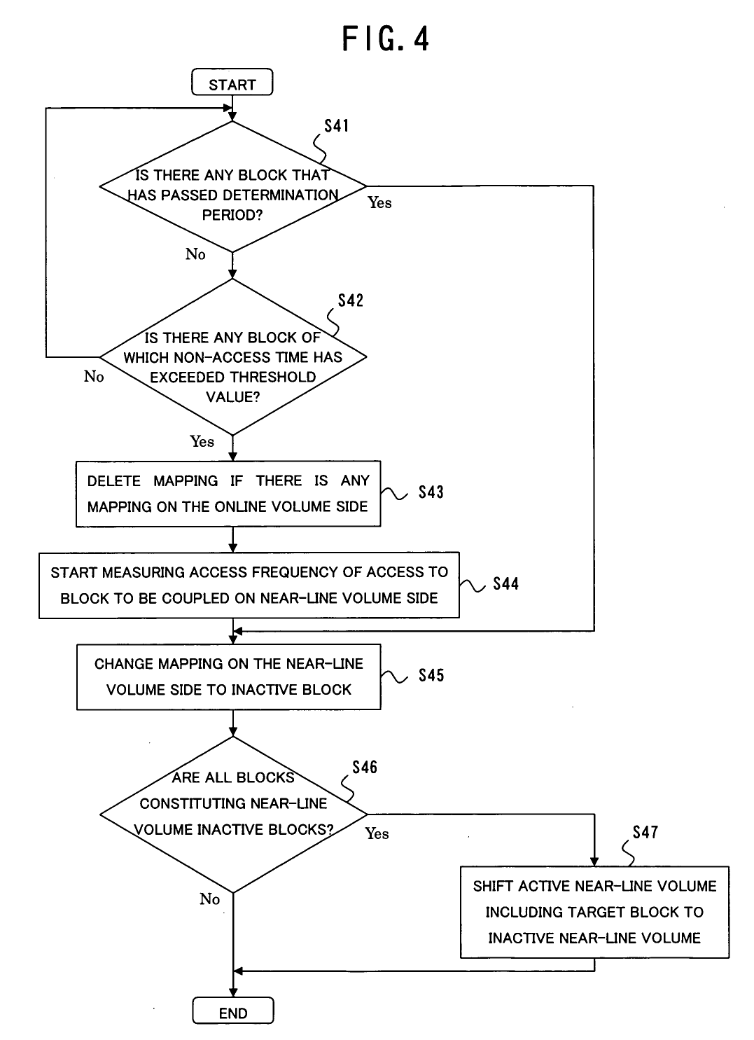

The control section 21 performs the first optimization processing on a block mapped by the mapping processing. FIG. 4 is a flowchart showing an example of operation of the first optimization processing according to the present invention.

At first, the control section 21 determines whether there is any block that has passed the determination period or not (S41), if there is a block that has passed the determination period (S41, Y), the control section 21 goes to a processing step S45. Otherwise, if no block has passed the determination period (S41, N), the control section 21 determines whether there is any block of which non-access time has exceeded the threshold value or not (S42). If there is no block of which non-access time has exceeded the threshold value (S42, N), the control section 21 returns to the processing step S41. Otherwise, if there is a block of which non-access time has exceeded the threshold value (S42, Y), the control section 21 deletes mapping existing on the online volume side (S43), and starts measuring frequency of access to a corresponding block on the near-line volume side (S44).

Next, the control section 21 changes the mapping on the near-line volume side to a non-active block (S45). The control section 21 next determines whether all the blocks that constitute the near-line volume are inactive blocks or not (S46). If several blocks are active blocks (S46, N), this flow is terminated. Otherwise, if all the blocks are inactive blocks (S46, Y), the control section 21 shifts the active near-line volume including a target block to the inactive volume (S47), and terminates this flow.

According to the first optimization processing, mapping of online blocks which are used at low use frequency is deleted, and only near-line blocks remain. The capacity of the online volume can thus be ensured. Also, near-line blocks are set as inactive blocks, and a near-line volume of which blocks have become inactive blocks is set as an inactive volume. Thus, power consumption can be suppressed.

Next, a second optimization processing will be described.

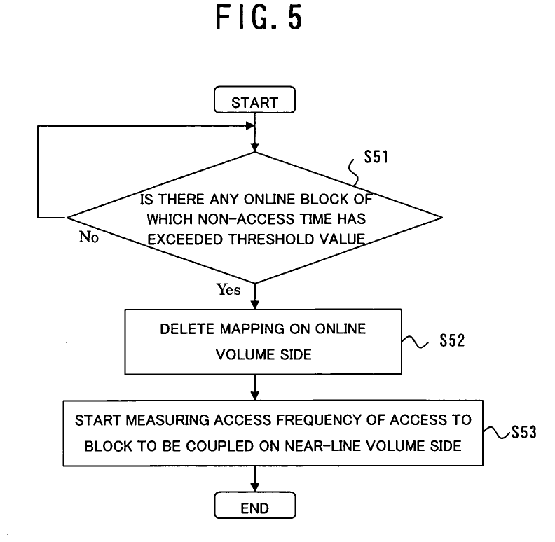

The control section 21 performs the second optimization processing on an online block after the first optimization processing. FIG. 5 is a flowchart showing an example of operation of the second optimization processing according to the present invention.

At first, the control section 21 determines whether there is any online block of which non-access time being measured has exceeded the non-access time threshold value or not (S51). If there is no online block of which non-access time has exceeded the threshold value (S51, N), the control section 21 returns to the processing step S51, and continues to measure and determine the non-access time. Otherwise, if there is an online block of which non-access time has exceeded the threshold value (S51, Y), the control section 21 deletes mapping on the online volume side (S52). That is, the control section 21 determines that use frequency of an online block as a target has lowered. Next, the control section 21 starts frequency of access to a block to be coupled on the near-line volume side (S53), and terminates this flow.

According to this second optimization processing, mapping of an online block which is used at low use frequency is deleted, and only near-line blocks are allowed to remain. Thus, the capacity of the online volume can be ensured.

Next, a third optimization processing will be described.

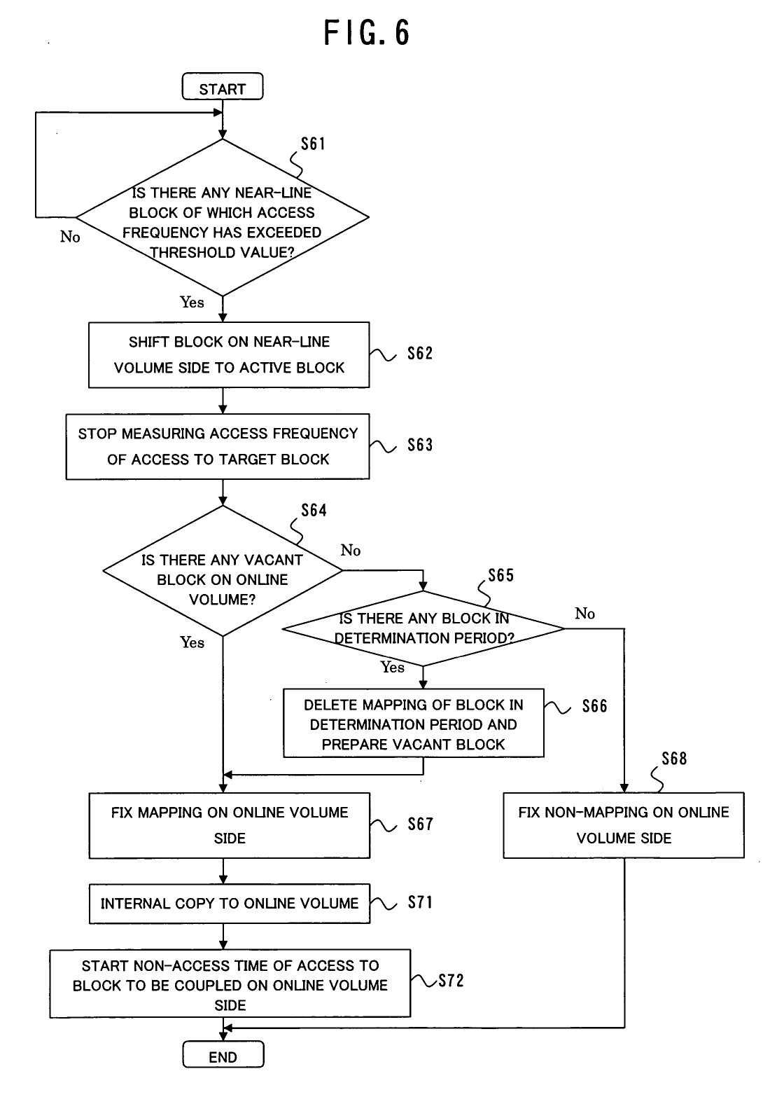

The control section 21 performs the third optimization processing on a near-line block after the first optimization processing or the second optimization processing. FIG. 6 is a flowchart showing an example of operation of the third optimization processing according to the present invention.

At first, the control section 21 determines whether there is any near-line block of which access frequency being measured has exceeded an access frequency threshold value or not (S61). If no near-line block has exceeded the access frequency threshold value (S61, N), the control section 21 returns to the processing step S61, and continues to measure and determine access frequency. Otherwise, if there is a near-line block of which access frequency has exceeded the access frequency threshold value (S61, Y), the control section 21 shifts a block on the near-line volume side to an active block (S62), and stops measuring frequency of access to a target block (S63).

Next, the control section 21 determines whether there is a vacant block in the online volume or not (S64 which is the same processing as S24). If there is a vacant block (S64, Y), the control section 21 fixes mapping on the online volume side (S67 which is the same processing as S27), and goes to a processing step S71. Otherwise, if there is no vacant block (S64, N), the control section 21 determines whether there is any block being in the determination period or not (S65 which is the same processing as S25). If there are blocks being in the determination period (S65, Y), the block that has the longest non-access time is deleted among the blocks being in the determination period, thereby to prepare a vacant block (S66 which is the same processing as S26). The control section 21 then goes to a processing step S67. Otherwise, if there is no block being in the determination period (S65, N), the control section 21 fixes non-mapping to be performed on the online volume side (S68 which is the same processing as S28), and terminates this flow.

Next, in the processing step S71, the control section 21 performs internal copying from the near-line volume to the online volume (S71). Next, the control section 21 starts measuring non-access time of the block to be coupled on the online volume side (S72). This flow is then terminated.

According to this third optimization processing, an online block is ensured corresponding to a near-line block which has come to be used at higher use frequency, and internal copying from the near-line block to the online block is performed. Thus, the online hard disk can be used efficiently, and so the response improves.

Other operations will be described next.

If mapping exists for both online and near-line blocks, Read is performed on the online block, and Write is performed on both the online and near-line blocks. At the time point when these blocks are accessed, non-access time is reset to zero.

According to this operation, performance of the online hard disk can be fully used at the Read and Write so that the response improves.

When the near-line volume as an inactive volume is accessed, a response is given taking this near-line volume as an active volume. If the near-line volume is not accessed further for a predetermined period, this near-line volume is changed to an inactive volume again. The predetermined period is, for example, a non-access time threshold value.

According to this operation, switching between active and inactive volumes can be prevented from occurring frequently. As a result, the response can improve.

The storage system control device according to the present invention is applicable with ease to a storage system and can improve performance of the storage system. Storages used in the storage system may include, for example, a single hard disk, a RAID device, and the like.

Further, a computer constituting the storage system control device may be let execute the processing steps described above by a program. This program may be provided as a storage system control program. The program may be stored into recording media readable from computers. Then, the program can be executed by computers. The recording media readable from computers may include an internal storage device such as a ROM or RAM built in a computer, a portable recording medium such as a CD-ROM, flexible disk, DVD disk, magneto-optical disk, or IC card, a database storing computer programs, another computer, a database thereof, and an online transfer medium.

A term of primary storage interface corresponds to the online hard disk interface described in the embodiment. Another term of secondary storage interface corresponds to the near-line hard disk interface described in the embodiment, as well. Further, terms of storage management step and storage control step correspond to processing performed by the control section of the embodiment.

What is claimed is:

1. A storage system control device which controls a primary storage and a secondary storage which drives at a lower speed than the primary storage, comprising:
a primary storage interface that performs writing into and reading from the primary storage;
a secondary storage interface that performs writing into and reading from the secondary storage; and
a control section that receives a write request from an external host computer and instructs the primary and secondary storage interfaces about writing if writing into the primary storage is possible.

2. The storage system control device according to claim 1, wherein
the control section receives a read request from the external host computer and instructs the primary storage interface about reading if reading from the primary storage is possible, or instructs the secondary storage interface about reading if reading from the primary storage is impossible.

3. The storage system control device according to claim 1, wherein
the control section receives a write request from the external host computer and instructs the secondary storage interface about writing if writing into the primary storage is impossible.

4. The storage system control device according to claim 1, wherein
the control section receives a write request for writing into an unused block, from the external host computer, assigns an assignable block in the primary storage to a primary block if there is any assignable block in the primary storage, and assigns another assignable block in the secondary storage to a secondary block.

5. The storage system control device according to claim 1, wherein
if a primary block satisfies a predetermined first condition, the control section deletes assignment to the primary block, and starts measuring access frequency of access to a secondary block corresponding to the primary block.

6. The storage system control device according to claim 1, wherein
if a secondary block satisfies a predetermined second condition and if there is an assignable block in the primary storage, the control section assigns the assignable block to a primary block corresponding to the secondary block, and copies data from the secondary block to the primary block.

7. The storage system control device according to claim 4, wherein
if there is no assignable block in the primary storage, the control section sets, as an assignable block, such a primary block that satisfies a predetermined third condition.

8. The storage system control device according to claim 5, wherein,
the first condition is that a time period for which the primary block as a target has not been accessed exceeds a predetermined non-access time period threshold value.

9. The storage system control device according to claim 6, wherein
the second condition is that access frequency of access to the secondary block as a target exceeds a predetermined access frequency threshold value.

10. The storage system control device according to claim 7, wherein
the third condition is that the primary block has the longest non-access time among primary blocks being in a predetermined determination period from mapping of the primary blocks.

11. The storage system control device according to claim 1, wherein
the control section manages each of the primary and secondary blocks as an active or inactive block,
if a block satisfies a predetermined condition and is determined as being accessed at low use frequency, the control section sets the block as an inactive block,
if all blocks in a physical volume in the secondary storage are inactive blocks, the control section stops the physical volume, and
if there is an active block in the physical volume, the control section lets the physical volume operate.

12. The storage system control device according to claim 11, wherein
if the primary block satisfies a predetermined fourth or fifth condition, the control section sets the secondary block as an inactive block, and
if the secondary block satisfies a predetermined sixth condition, the control section sets the secondary block as an active block.

13. The storage system control device according to claim 12, wherein
the fourth condition is that before a predetermined determination period elapses from mapping of a primary block as a target, a time period for which the primary block has not been accessed exceeds a predetermined non-access time threshold value,
the fifth condition is that before a predetermined determination period elapses from mapping of a primary block as a target, a time period for which the primary block has not been accessed does not exceed a predetermined non-access time threshold value, and
the sixth condition is that access frequency of access to a secondary block as a target exceeds a predetermined access frequency threshold value.

14. A storage system control program which makes a computer execute control of a primary storage and a secondary storage which drives at a lower speed than the primary storage, comprising:
a storage management step that receives a write request from an external host computer and determines whether writing into the primary storage is possible or not; and
a storage control step that gives an instruction about writing into the primary and secondary storages if writing into the primary storage is determined to be possible by the storage management step.

15. The storage system control program according to claim 14, wherein
the storage management step receives a read request from the external host computer, and determines whether reading from the primary storage is possible or not, and
if reading from the primary storage is determined to be possible by the storage management step, the storage control step instructs a primary storage interface about reading, or if reading from the primary storage is determined to be impossible by the storage management step, the storage control step instructs a secondary storage interface about reading.

16. The storage system control program according to claim 14, wherein
if writing into the primary storage is determined to be impossible by the storage management system, the storage control step instructs the secondary storage interface about writing.

17. The storage system control program according to claim 14, wherein
the storage management step receives a write request for writing into an unused block from the external host computer, assigns an assignable block in the primary storage to a primary block if there is an assignable block in the primary storage, and assigns an assignable block in the secondary storage to a secondary block.

18. The storage system control program according to claim 14, wherein
if a primary block satisfies a predetermined first condition, the storage management step deletes assignment to the primary block, and starts measuring access frequency of access to a secondary block corresponding to the primary block.

19. The storage system control program according to claim 14, wherein
if a secondary block satisfies a predetermined second condition and if there is an assignable block in the primary storage, the storage management step assigns the assignable block to a primary block corresponding to the secondary block, and
the storage control step copies data from the secondary block to the primary block.

20. A storage system control method of controlling a primary storage and a secondary storage which drives at a lower speed than the primary storage, comprising:
a storage management step that receives a write request from an external host computer and determines whether writing into the primary storage is possible or not; and
a storage control step that gives an instruction about writing into the primary and secondary storages if writing into the primary storage is determined to be possible by the storage management step.
